(19) United States
(12) Patent Application Publication
(10) Pub. No.: US 2017/0185692 A1
(43) Pub. Date: Jun. 29, 2017

(54) App group, ad bandwidth, hand off for linket and mobile deep links

(71) Applicant: Wesley John Boudville, Perth, WA (US)

(72) Inventor: Wesley John Boudville, Perth, WA (US)

(21) Appl. No.: 14/998,349

(22) Filed: Dec. 28, 2015

(51) Int. Cl. G06F 17/30; G06K 7/10; G06K 7/14

(52) U.S. Cl. CPC G06F 17/30879; G06K 7/1413; G06K 7/10722

(57) ABSTRACT

Users establish an individual or collective brand that uses their expertise with a mobile app. A linket is a label for a deep link. A deep link is at minimum 2 items. An id of an app and a network address or domain where the app is run. A Registry maps from a linket to a deep link. A linket owner defines a group of apps and a group id. The linket maps to a deep link that uses the group id instead of an id of a specific app. The apps in the group might be run in student mode. The address in the deep link is of an instance of another app that acts as a teacher or instructor. A group can have subgroups. This can be used to download app ids suitable for different mobile platforms, such that a mobile device can parse the appropriate ids for itself. An ad server that sends ads to 2 instances (on different devices) of an app can send an ad to only one instance. The latter shows the ad on its device and also forwards it to the other instance. This reduces the outgoing bandwidth on the ad server by half. If the user of the first device picks an item on the first ad, this choice can be sent to and shown on the second ad. A game can be played between the ad instances, independent of the underlying interactions between the app instances. A person using an app in a multi-user interaction with other persons can hand off her instance to someone. She makes a deep link that has an id of her app instance, known the app server. The deep link is sent to another person not currently in the interaction. His device decodes the deep link and presents it wirelessly to the server. The server transfers her “game position” to the network address of his device. He can play her position in the interaction.

### REFERENCES CITED

“Apps everywhere but no unifying link” by C. Dougherty, New York Times, 5 Jan. 2015.
“Deep linking's big untapped potential” by M. Thomson, VentureBeat.com, 9 Aug. 2015.
“Generating and presenting deep links” by V. Tankovich et al, US Patent Application 20130110815 (Oct. 28, 2011).
“Methods and systems for facilitating an online social network” by C. Evans, US Patent Application 20140089413 (Dec. 6, 2013).
“Text-synchronized media utilization and manipulation based on an embedded barcode” by C. Evans, US Patent application 20130334300 (Mar. 27, 2013).
“Smart link system and method” by J. Chor, U.S. Pat. No. 8,433,800, (28 Feb. 2011).
“Deep linking to mobile applications” by S. Saxena et al US Patent Application 20150154644 (Dec. 2, 2013).
“Deep linking to mobile applications” by S. Saxena et al US Patent Application 20150156061 (Dec. 2, 2013).

### TECHNICAL FIELD

Deep links for mobile apps.

### BACKGROUND

Mobile apps have a distinctive problem. Most are currently standalone programs that often just converse with an app server run by the company that wrote the app. The apps do not have URL links within them. In general, an app from one company does not interact with an app from another company. Separately, it is much harder for a search engine, which is optimised to search the Web for webpages, to search arbitrary apps. There is no standard syntax equivalent to an URL or URI to enable this.

To enable such and other functionality in mobile apps has been termed ‘deep linking’ within apps. (The term also has an earlier use that refers to standard web pages and URL links within them. This submission does not use that earlier meaning.)

Major companies have several projects aimed at defining deep links. Facebook Corp. has App Links. Google Corp. has App Indexing and Google Intents. Twitter Corp. has App Cards. Apple Corp. has Apple Extensions. Yahoo has 2 US patents pending. There are also several startups, like Bit.ly, Branch Metrics Corp., Button Corp., Quixy Corp., URX Corp., and Tapstream Corp., each with their own initiatives. The syntax and functionality vary between these company specific efforts.

We recommend that if the reader is new to the idea of deep links to read 2 articles. “Apps everywhere but no unifying link” by C. Dougherty, New York Times, 5 Jan. 2015. And “Deep linking's big untapped potential” by M. Thomson, VentureBeat.com, 9 Aug. 2015. Both at least at this time of writing are available online. They are well written. The first article is accessible to the general reader. The second article has slightly more technical details. They give an understanding of deep links and the business potential, as understood publicly in the prior art of 2015.

### SUMMARY

A linket is a label for a deep link. A deep link is at minimum 2 items. An id of an app and a network address or domain where the app is run. Often the app runs on a mobile device. The address is assigned to the device by the wireless provider or WiFi hot spot. A raw address is hard to remember. And it can change as the user moves. A linket functions like a domain name. Stable and easier to remember.

A Registry maps from a linket to a deep link. The analog of the DNS system. But whereas the mapping from a domain to an IP address is expected to be stable over months, the deep link address can change over hours.

A linket owner defines a group of apps and a group id. The linket maps to a deep link that uses the group id instead of an id of a specific app. The apps in the group might be run in student mode. The address in the deep link is of an instance of another app that acts as a teacher or instructor. A group can also have an associated app that runs in teacher mode, while the apps in the group run in student mode. When an app gets updated by its owner, the Registry can check that the groups using the (old) app can still function with the new app. Else it contacts the app owner and group owner.

A group can have subgroups. This can be used to download app ids suitable for different mobile platforms, such that a mobile device can parse the appropriate ids for itself.

A use of subgroups is that the first subgroup [for example] can be of apps for Android™, and the second subgroup can be of apps for Apple Corp.'s iPhone™.

An ad server that sends ads to 2 instances (on different devices) of an app can send an ad to only one instance. The latter shows the ad on its device and also forwards it to the other instance. This reduces the outgoing bandwidth on the ad server by half. If the user of the first device picks an item on the first ad, this choice can be sent to and shown on the second ad.

If the user of the second device then makes a change on her ad, this can be sent to the first ad. This produces a feedback loop and a game that can be played on the ads, separate from the apps on the 2 devices that show the ads.

A person using an app in a multi-user interaction with other persons can hand off her instance to someone. She makes a deep link that has an id of her app instance, known the app server. The deep link is sent by various means to another person not currently in the interaction. His device decodes the deep link and presents it wirelessly to the server. The server transfers her “game position” to the network address of his device. He can play her position in the interaction.

### BRIEF DESCRIPTION OF THE DRAWINGS

FIG. 1 shows deep links in the prior art and the present submission.

FIG. 2 shows a group id being used in a deep link.

FIG. 3 shows a window on a user device, describing apps in a group.

FIG. 4 shows a group having subgroups for teaching ESL.

FIG. 5 shows a updated group app breaking an interaction with another app.

FIG. 6 shows teacher apps with an API interacting with a group of student apps.

FIG. 7 shows instances of the same app getting ads from an ad server.

FIG. 8 shows an ad server telling an app to forward an ad to another app.

FIG. 9 shows 2 ad instances on different devices interacting directly.

FIG. 10 shows different apps interacting with the same ad server.

FIG. 11 shows a hand off between a player and another user.

FIG. 12 shows the player data in the server before and after hand off.

### DETAILED DESCRIPTION OF THE PREFERRED EMBODIMENT

What we claim as new and desire to secure by letters patent is set forth in the following claims.

This submission refers to our earlier submissions to the US PTO: “Cellphone changing an electronic display that contains a barcode”, filed 16 May 2011, U.S. Pat. No. 8,532,632 [“1”]; “Using dynamic barcodes to send data to a cellphone”, filed 28 Jul. 2011, U.S. Pat. No. 8,348,149 [“2”]; “Transmitting and receiving data via barcodes through a cellphone for privacy and anonymity”, filed 4 Oct. 2011, U.S. Pat. No. 8,707,163 [“3”]; “Colour barcodes and cellphone”, filed 16 Dec. 2011, U.S. Pat. No. 8,821,277 [“4”]; “Mobile device audio from an external video display using a barcode”, filed 25 May 2012, U.S. Pat. No. 8,708,224 [“5”]; “Dynamic group purchases using barcodes”, filed 29 May 2012, U.S. Pat. No. 8,655,694 [“6”]; “Chirp to control devices”, filed 9 Oct. 2012, US patent application 20140098644 [“7”]; “Barcode-based methods to enhance mobile multiplayer games”, filed 22 May 2013, US patent application 20140349746 [“8”]; “Barcode, sound and collision for a unified user interaction”, filed October 2013, US patent application 20150113068 [“9”].

We have these co-pending applications for deep linking:

“Deep linking of mobile apps by barcode, sound or collision”, filed Feb. 18, 2015, U.S. patent application Ser. No. 14/544,763 [“10”],

“Cookies and anti-ad blocker using deep links in mobile apps”, filed Jun. 8, 2015, U.S. patent application Ser. No. 14/545,694 [“11”];

“Blockchain and deep links for mobile apps”, filed Jul. 28, 2015, U.S. patent application Ser. No. 14/756,058 [“12”];

“Different apps on different mobile devices interacting via deep links”, filed Aug. 18, 2015, U.S. patent application Ser. No. 14/756,208 [“13”].

“Linket to control mobile deep links”, filed Oct. 19, 2015, U.S. patent application Ser. No. 14/756,815 [“14”].

“Capacity and automated de-install of linket mobile apps with deep links”, filed Nov. 10, 2015, U.S. patent application Ser. No. 14/757,027 [“15”].

“App social network via linket and ads for mobile deep links”, filed December 2015, US patent application [“16”].

We described deep links and ways that these could enhance interactions between two mobile devices near each other. The current submission describes a higher level of use of deep links.

We define some terminology.

This submission is mostly about mobile devices carried or worn by people. The most common mobile device is a cellphone. We take this word to also include “smartphone”. The latter term arose to describe a cellphone that also had a camera and Internet access, when such features were relatively new to cellphones. Other types of mobile devices are tablets, laptops, notebooks, netbooks, PDAs and wearable devices.

We will make frequent references to “app store” and “app server”. Despite the similarity in names, these are different entities. An app store is typically run by a maker of a mobile device (like Apple Corp., Microsoft Corp.), or a provider of an operating system for mobile devices (like Google Corp.). Software companies that make mobile apps submit these to an app store. So users can find the apps in the app store and download them to the mobile devices. An app server is a server run by one of those software companies. A mobile user can use her device browser to go to the website of the app server, to download the app.

When we later describe an instance of an app interacting with an instance of another app, we might say, for brevity, a statement like “the first app interacts with the second app”, when strictly it should be “an instance of the first app interacts with an instance of the second app”. There should be no confusion with the use of the shorter phrase. But when 2 instances of an app interact with each other, a more precise phrasing is needed, like “a first instance of the app interacts with a second instance of the app”.

Related to this is a notational convenience. We shall refer to an app, and call it Alpha, for example, in the text and figures. Sometimes “Alpha” shall mean the app executable. Other times, it shall mean the id of the app, where the id is unique across “all” apps. In turn, “all” might mean across all apps in an app store for a given hardware platform. Or across all hardware platforms.

This submission has the following sections.

1: Earlier submissions;

2: Registry and Groups of Apps;

2.1: Ads and Groups;

2.2: Subgroups for apps for different platforms;

3: Automated checking of new app versions;

4: Minimising ad bandwidth;

4.1: Different Instances of an App;

4.2: Several Apps;

5: Dynamic deep links;

6: Hand off;

1: Earlier submissions;

This submission extends our work in submissions 14 and 15. We encourage the reader to read those for a fuller discussion of linkets. In this section, we summarise our earlier work.

The prior art uses “deep link” to mean two apps running on one mobile device. The first app has a deep link which is selectable by the user. When the deep link is selected, something happens to cause the second app to be installed on the device. Since typically the second app is not present. The second app is run, with an input argument which causes it to start up and show a particular item or “page”, rather than just a generic “home page”. The “something happens” refers to different ways that different companies have, to enable this.

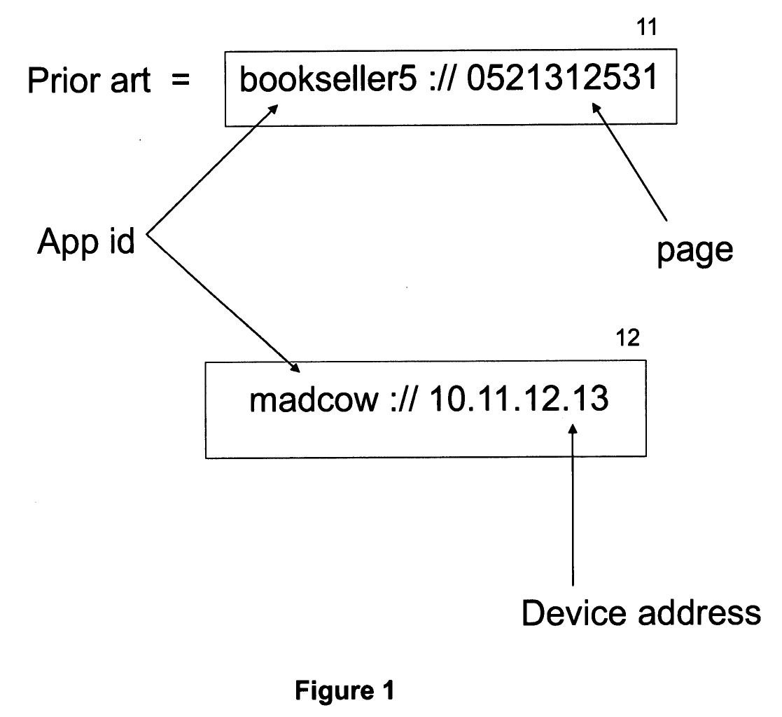

FIG. 1 is FIG. 1 of submission 14. Item 11 is a deep link in the prior art.

Our deep link, as defined in submissions 10-15, is fundamentally different. It lets 2 mobile devices interact. One major category is one app running on 2 mobile devices. By one app, we mean 2 instances of the app. Another category is 2 apps running on 2 mobile devices. One app runs on one device, another app runs on the other device, and the apps interact. Our deep link is for (though not exclusively) multiuser interactions. The category of one app on 2 devices can be for multiplayer games. Or even a single player game, where the second device runs a second instance of the game in spectator mode. The second device screen shows the game window of the first device. But the second device cannot alter. Read only.

Item 12 is a deep link from our submissions. It has an id of an app, “madcow”. But it also has a network address, 10.11.12.13, of a device (like a cellphone) running an instance of madcow. Suppose madcow is a two person game. The first person, Jane, has her phone at that Internet address. She starts madcow. She needs a second player. She picks an option in the game that makes the deep link 12. She sends this perhaps via an electronic message to Bob. In general, he does not have madcow installed on his device. He reads the message in a mobile browser. The browser shows the deep link as a clickable link. Bob clicks it. The browser, perhaps in tandem with the device operating system, installs madcow and runs an instance. Giving it the input 10.11.12.13. This tells Bob's madcow instance to connect to another madcow instance at that address. Jane and Bob now play the game.

We define a “linket” to be the label of a deep link. The linket can be expressed in Unicode. The linket can be case sensitive. Unlike domain names. This improves the readability of expressions. Case sensitivity is moot for languages like Chinese or Hindi which do not have the concept. The linket can have (but not necessarily) white space.

The linket lets individuals have a personal brand associated with themselves. This follows the observation that many (most ?) people in many countries now have cellphones. A user's cellphone becomes an extension of herself, as has been observed. It is the most common type of personal computer in the world.

Hence a person can own a linket. Of course, a corporation can also own a linket.

Another trend observed is the rise of the so-called gig economy, as exemplified by companies like Uber, Lyft and Airbnb letting individuals offer their services. Where the labour market tends to a friction free state. Our linket and the personal branding it offers is another enabler of the trend.

For descriptive simplicity in what follows, we shall write the linket as a string enclosed in quotes. This is meant to describe its string contents in an understandable way that is independent of a choice of format.

2: Registry and Groups of Apps;

In FIG. 1, item 12 described our deep link, where there was an app identifier and a network address. The identifier of a specific app can be extended to being an identifier of a group of apps. Why? Submission 13 explained how different apps could interact with each other via deep links, if they implemented an appropriate API for the network interaction. Suppose our user Jane has a linket about teaching ESL. This is her brand. She uses a specific app Alpha as a teacher. But this app can interact with not just another instance of itself, but also with other apps. The latter apps let their users be students of the subject she teaches.

As terminology and for brevity, we may say “teacher app” to refer to either an app that is exclusively run in teacher mode (it cannot be run in student mode) or to an app that can be run in teacher or student mode. For the latter, “teacher app” means the state where the app is run in teacher mode.

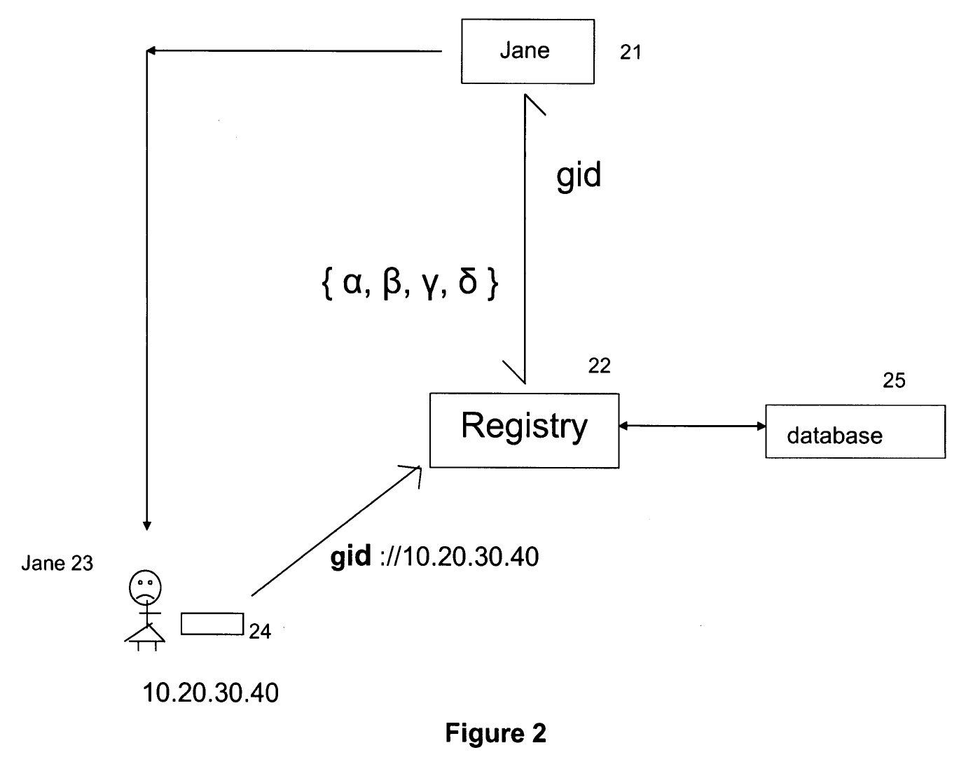

Jane defines this group of apps that her app is compatible with. See FIG. 2. Jane 21 refers to Jane and her device. She makes a list of the app ids and uploads these to Registry 22. The apps are depicted as the set {Alpha, Beta, Gamma, Delta}. In this set, one of the apps might preferably be the same as her teacher app, Alpha. But this is not a necessity.

As with app Alpha, Jane in general does not work for any of the app companies or own any of the apps in the set she just defined.

The Registry gets the set and searches its database 25 for any existing set that is the same as Jane's set. If the set already exists, by assumption it already has a group id (gid), and the Registry uses this gid. Else the Registry makes a new gid, different from all the other gids defined across all groups. The gid is sent to Jane, as shown in the figure.

Or even if there is an existing group, defined by someone else, with apps identical to what Jane just uploaded, the Registry might let her define a ‘new’ group, with her gid and contents. The Registry may preferably require that if it accepts Jane's proferred and uploaded gid as the group id of her group, that this gid be different from all other gids.

Lower in FIG. 2, Jane 23 and her device 24 are at some location. The arrows from Jane 21 to Jane 23 indicate that her spatial location could have changed, or perhaps she is in the same place at a later time. Her device has the network address 10.20.30.40. Her device makes the deep link gid://10.20.30.40 and uploads this to the Registry. Suppose she already has a linket registered at the Registry. Her uploading of the deep link can have associated security parameters to let the Registry associate the new deep link with her pre-existing linket. Clearly, measures have to be taken here, to prevent someone else taking over her linket by having it point to his deep link. (The measures are the same as for the earlier cases where she is not using a group id but an app id, and she moves and gets a new network address, which is then uploaded to the Registry.)

At some later time, suppose she still has this network address. A user Ralph gets her linket by any means and wants to learn from her. His device sends it to the Registry. The Registry gets the associated current deep link for Jane. It extracts the gid from her deep link and sees that it refers to a group of apps. It returns the group to Ralph's device with possibly some ancillary information about the groups.

Typically the Registry will not or should not just send the group name/id and her network address to his device. Because he will then ask the Registry for the contents of the group. So to reduce the network interactions, the Registry takes the initiative by sending the group contents.

His device sees that there are several app ids, not just one. It can pop up some window, to show information about the apps and to let Ralph pick one for installation. If he does so, then after it is installed and started with Jane's network address, his app instance contacts whatever app Jane has at her address, waiting for this query.

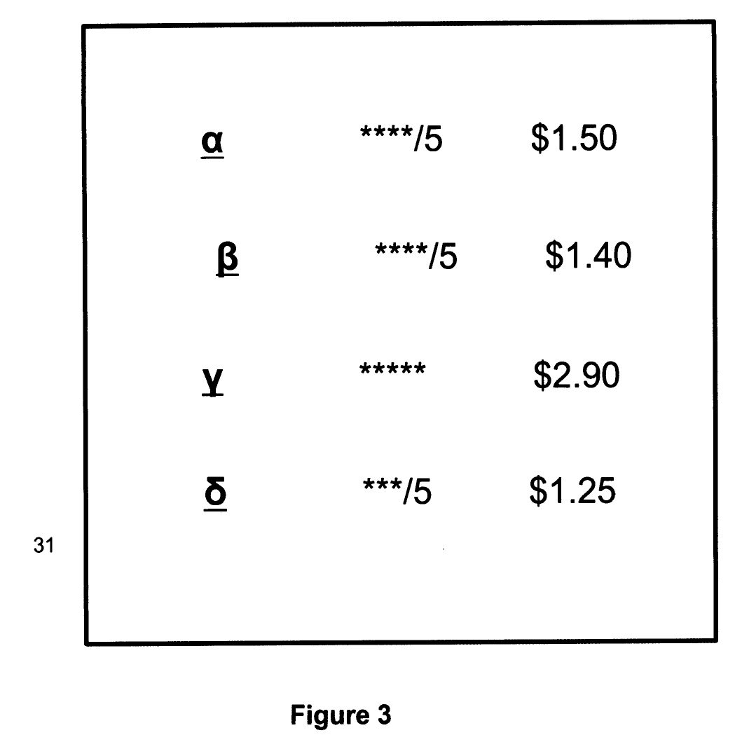

See FIG. 3. Item 31 is a window that appears in Ralph's device. It shows the apps in the group from FIG. 2. Each app is depicted with an underline symbol. This tells Ralph that he can pick it to download and install. For each app, there is summary information about it sent from the Registry. A rating, for example. And a cost. The cost might be for the download. Or for using it for the first week, etc. The reader will see that for disparate apps written by independent companies, how the cost is defined will vary. Hence in some fields (like the ESL example here), there might arise a standard voluntary cost structure that app companies use, for easy comparison by users.

Or Ralph might have earlier instructed his device to use a default choice. Several strategies are possible. One is for his device to see if any app in the group is already on his device. If so, and if there is only one, then there is no need to install another. Quicker and saves incoming bandwidth. So his device uses that app to contact Jane. If several apps in the group are already on his device, then it can pick one at random, for example.

More likely, none of the apps in the group are on his device. His device can use various heuristics to pick and install one. For example, if an app is free to download and another app is not, then the device can pick the former, all else being equal.

Thus when the Registry downloaded information about the apps in the group, the information could include pricing as per FIG. 3.

Now suppose for simplicity there are only two apps in the group—Phi and Theta. Both are free or the same price. But Phi is smaller than Theta. Suppose this information comes with the group, or his device asks the Registry. Then Phi could be picked, because it takes less bandwidth to download and it uses less storage.

But if Phi is smaller than Theta and Theta is cheaper than Phi then the heuristics on size and price have to be resolved. One way is to popup a window explaining this to Ralph and let him pick manually.

Or the heuristics can be ordered in some way. At some earlier time by Ralph, or by his device using a default ordering. Suppose the first heuristic is size and the second is cost. An app satisfying the first might usually be picked over one satisfying the second.

Extensions are possible. How did she define that group of apps? To start with, suppose Jane picked a given app, say Alpha, from which she wants to teach. She installed it on her device. Running it can tell her which other apps are compatible with it; with Alpha in teacher mode and those in student mode. She can search the Registry using the search term ‘esl’ to find all apps associated with her subject. She might download several and try running each in student mode against Alpha in teacher mode. Those apps that can do so, she adds to her group.

In passing, for the earlier case where an app Alpha can be used by both the teacher and student, the app could by default come up in student mode. Because most of the users can be expected to be students. While the teacher mode is where the user has to do an extra step to be teacher.

Or, when Jane makes a deep link, that a student would get and use, the deep link could have a parameter after the network address. This tells the instance that it is in student mode. For example, the deep link might be “alpha://10.20.30.40/k=s”, where 10.20.30.40 is the address of Jane's instance, in teacher mode. While the “k=s” means that the instance started by a user gets this as input, telling it to be in student mode.

Now when she is using a group of apps, there could be a common simple syntax of the arguments in the deep link. So the “k=s” can tell the app instance that extracts this from the deep link that it is in student mode. Some or all of the apps in the group of apps may adhere to this syntax convention.

Or Jane can upload Alpha's id to the Registry. And ask for all groups that Alpha is a member of. Alpha could be in several groups, defined by others. Jane can pick a group and download some or all of the apps in the group. She can run these in student mode, if possible. She can pick the apps from the group to be her student apps. If there are 2 groups, she might pick some apps from one group and combine these with some apps from the other group, to make her new customised group of apps.

Of course she might just default and use an existing group of apps that can be run as student apps vis a vis her Alpha teacher app. In either case, the Registry acts as a resource, by advising her on how to make her set of apps.

Earlier, we described how if Jane uploads a set of apps that define a group, the Registry searches its database to see if the set matches an existing group. If so, then the group id of that group would be downloaded to Jane. A variant is where Jane can define a group id for a group whose members she defines, or where that group already exists in the database. Here, the group id she defines needs to be unique across all the group ids in the database. The reason to let her do this is that a given group might have several names (ids). So a search option for using the Registry can be to search for group ids.

Suppose there is an existing group, defined by Larry, that is the same in terms of contents as a group uploaded by Jane. Suppose she uses or has to use Larry's group id. There are at least 2 problems. First, Larry's group might satisfy 2 APIs. One API is the same as the API for Jane's group. Another API is for a different purpose. It might be that by coincidence, Larry defined his group to satisfy the second API. His use of the group does not use the first API. Later, Larry decides to alter the group by adding an app that satisfies the second API but not the first. This new app will break when a potential student of Jane's uses it to try to connect to Jane's app via the first API.

The second problem is suppose there is only one API. Larry at a future time adds an app Chi that satisfies the API. But Chi charges a download fee that is more than what Jane wants her students to be charged. (She also charges them her tutoring fee.) Because Jane does not control the group, she cannot do anything about removing Chi. The broader point is that the group of apps that satisfy a given API does not necessarily mean that a teacher will want to use all those apps. She can have other criteria to narrow down to a subset.

The Registry can let a group contain a (sub)group or groups. Down perhaps to some maximum level. There could be a precaution against circular referencing. Where group A refers in part to group B. And group B has a reference to group A.

The use of a group inside another group is to handle the case where a group has many apps, in a flat structure and the group owner wants to introduce some hierarchical structure for easier use. As in a file system, where a directory can have subdirectories.

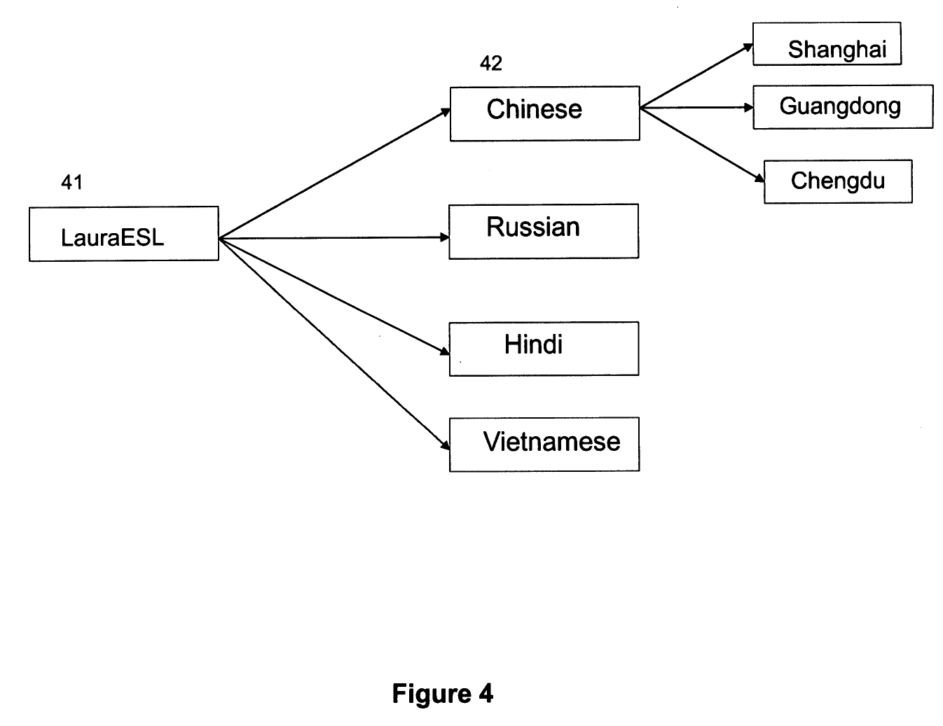

FIG. 4 gives an example of a group having groups within it. Item 41 is a group with the group id LauraESL. Laura is teaching English as a Second Language. She has (sub)groups called Chinese, Russian, Hindi and Vietnamese. These refer to the first or native languages of the students. Each subgroup can have several apps labelled for those first languages. And a Chinese app, for example, can have a teacher who speaks Chinese.

This can be taken further. The Chinese subgroup 42 has 3 apps, called Shanghai, Guangdong and Chengdu. Each app could be customised for the first language (Chinese/Mandarin), but each app is also specific to the accent of a given region. The Mandarin spoken in Shanghai sounds different from that in Chengdu, for example.

A variant is where instead of the previous 3 items all being apps, the Shanghai item might be a subgroup. It points to several apps, all directed to users with a Shanghai accent.

In FIG. 2, consider again the group id, gid, depicted. One variant is where the group label can itself have semantic value. So when Jane uploads the set of app ids, she might also upload a tentative gid, like “JaneStudentApps”. This can be part of her branding. If the Registry does not find any existing group to be the same as her uploaded group, then it might use her uploaded group label as the group id.

For this, the Registry could charge her. Akin to how a (US) Department of Motor Vehicles can charge a driver for a personalised license plate. Also, now if others search the groups in the Registry, her gid and group can be found. Her group id can be valuable marketing for her. A group of such apps can be considered similar to a playlist of songs.

There could be different conditions on the format and contents of the group id compared to those of the linket. For example, the group id might not be allowed to have white space, while the linket might be able to. The maximum length of the gid could be different from that of the linket. The group id might be restricted to ASCII characters, while the linket can be written in Unicode. Though if possible, this submission strongly urges that the group id be written in Unicode, to increase its appeal and use globally.

Consider the owner of a group. She can add new apps to it and remove apps from it. What if she removes apps until there is only one app in the group? The Registry can permit this. Perhaps because at some future time she might add more apps. Also, when a user defines a new group, as a practical matter she likely adds apps one at a time to it. So the group would start with only one app, which is equivalent to the above scenario.

Suppose Jane owns a group id and she wants to rename it. The Registry can permit this.

Perhaps for a price. It can also maintain a link or alias from the old group name to the new group name. So a user uploading a deep link with the old group name gets results that use the new group name. Related to this, the Registry might also send a message indicating that the group name has changed.

If a group id can be owned, then the Registry can also let it be sold to another party.

2.1: Ads and Groups;

Section 3 of submission 16 described interactions where the Registry and an ad server sent ads to users who uploaded linkets or deep links to the Registry. For the current section, similar actions can be done. Suppose a group is for teaching ESL. There can be competing groups of apps, to teach ESL.

For a given group, the Registry can make a set of ads from competitors. They have linkets that use apps in the group, or use apps not in the group, but also for the same purpose or topic as the group. Competitors could also be other groups for ESL.

Suppose the owner of a group adds an app XYZ to it. The Registry can show ads from linkets using XYZ. Or suppose the owner of a group deletes app XYZ in it. The Registry can still for some period of time after the deletion, use ads for linkets using XYZ. The point here is that some prior users of the group could have been using XYZ, and might still want to after it was dropped. The ads can induce them to keep using XYZ via other linkets.

Suppose Jane deletes her group. A user who sends a linket or deep link referring to the group can get ads from other groups or linkets or deep links teaching ESL.

2.2: Subgroups for Apps for Different Platforms;

A subgroup is simply a group that is in another group. Another use for a group having subgroups is to handle apps meant for different platforms. By this we mean that a given app might be run only on Android, while another app only runs on Apple's iPhone. In our earlier submissions, the deep link only had the id of one app. But the mobile device getting the deep link in order to probably install an app needs an app id suitable for its platform.

One answer is to use groups. A group g might be an ordered list of subgroups. So g=(g[0], g[1], g[2], . . . ).

Here, g[0]=ids of apps that run on Android, g[1]=ids of apps that run on iPhone, g[2]=ids of apps that run on iPad, g[3]=ids of apps that run on Microsoft Phone, g[4]=ids of apps that run on Blackberry, g[5]=ids of apps that run on Tizen. Etc.

In turn, a subgroup can be written as g[i]={abc, def, jkl, . . . }, where each entry is an id of an app, written in the notation of that platform i.

If there are no apps for a given platform, then the group can be left empty, to tell the mobile device parsing the deep link. Each position in the top group's vector refers to a specific platform. So position 0 can be Android as depicted above. A given mobile device has a given platform. The device operating system knows the position in the top group's vector of apps suitable for itself. So it parses the top group until it finds that position. Then it parses the list of apps for that subgroup.

Suppose the Registry gets a linket from a mobile device, and the Registry can determine the platform (perhaps from other information sent from the device). It can use the full deep link it has for that linket (as sent to it from the linket owner). It makes a deep link by zeroing out the groups for other platforms and then downloads the deep link. Reduces the bandwidth. And the mobile device can do faster parsing, by having a shorter string to parse.

3: Automated Checking of New App Versions;

The previous section discussed where the group of apps could have an app run in teacher mode by Jane, but is in the group because it can be run in student mode. There was no necessity for any app in the group to be used by Jane as a teacher or instructor. There is no simple automated way thus far explained for the Registry or a person's device to infer which program Jane would use on her end. Would it be one of the apps in the group, and if so, which one? Or would it be some program not in the group. The latter case has an undefined solution if the problem is to find Jane's program knowing only the group.

Now suppose when a group is defined by Jane and uploaded to the Registry, she also uploads the id of the teacher app that she uses. So for the earlier example of a group in FIG. 2, she now uploads the pair (Alpha, {Alpha, Beta, Gamma, Delta}). The first Alpha indicates the teacher app she uses. When Alpha appears in the set, this means it can run in student mode. In passing, note that the following apparent abbreviation will not work. Where she uploads just the set, as earlier, but the first app in the set is also considered to be the teacher app used by her. Just coincidence. It should not be assumed that this will always be the case in other groups. For example, a teacher app might be written that cannot be run in student mode. So an explicit rendition of the id of the teacher app is recommended, and being outside the group of student apps.

Why should Jane tell the Registry the teacher app associated with the group? It allows the following automated steps that can be done by the Registry.

We have the teacher app Alpha and the student apps Alpha, Beta, Gamma, Delta. In general, the student apps will be owned and maintained by different companies. Over time these can be upgraded to new versions. Suppose Beta is revved. There is no guarantee that its company will test that it is still compatible in student mode with Alpha in teacher mode.

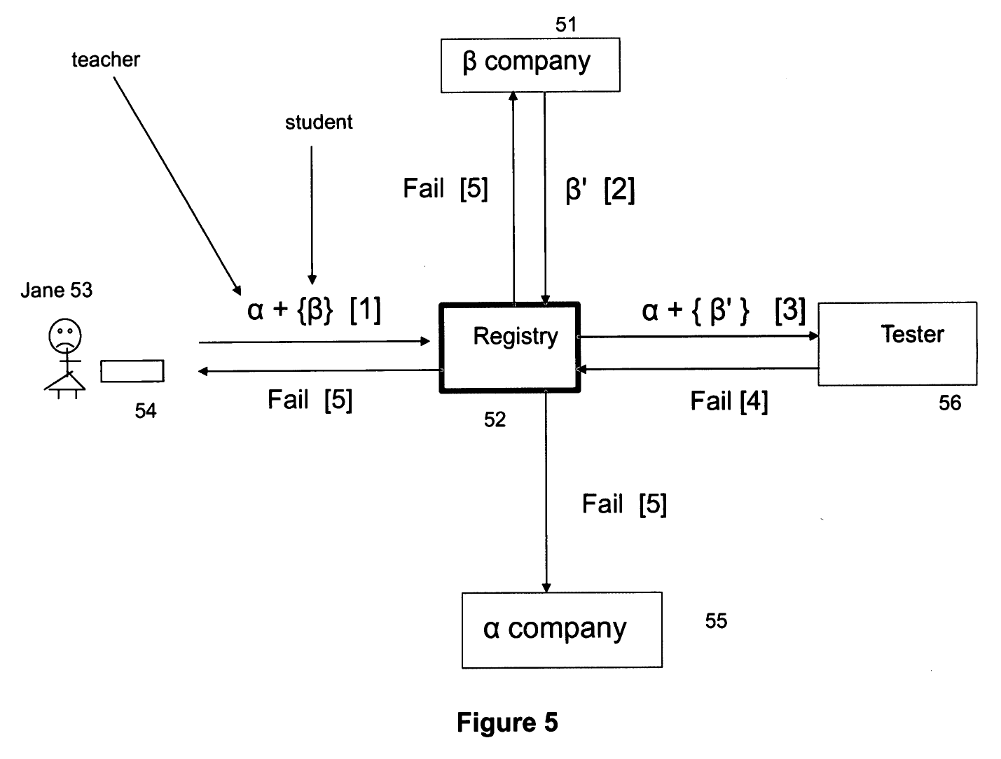

FIG. 5 shows this. Jane 53 uses her device 54 to define a teacher app Alpha and a group of only one app, Beta, being uploaded to Registry 52 in step [1]. Simply for graphical clarity, we just depict the group as one app in this figure.

After Beta is revved, its company might tell the Registry. In step [2], the Beta company 51 makes a new Beta prime and tells the Registry. In step [3], the Registry sends Alpha and Beta prime to Tester 56. This can be a subsystem of the Registry or a different machine.

Or suppose the Registry finds out about Beta prime by any other means. The Registry finds all the groups containing Beta, like the one above. For each the associated Tester does the following. It tests (to the extent it can) running the teacher app Alpha against Beta prime. This might be done via one or two virtual machines (VMs). It might put Alpha into one VM and Beta prime into another VM. And give both app instances addresses on an internal network. Then the instances are run against each other in some simple tests.

If Beta prime does not work against the teacher app Alpha, then the Tester tells the Registry in step [4].

The Registry can tell the company 55 maintaining Alpha, in step [5]. It can also tell Beta company 51 in this step. It also tells Jane, who defined the above group that interacts with Alpha. It can charge a fee to Jane, for her to get update information. There is value here for her to get this, because if a potential student uses Beta prime, he cannot be her student. She loses revenue. The Registry could also charge the Alpha and Beta companies for the information.

If Beta prime works with Alpha, the Registry might update the group by replacing Beta with the latest version. Or it can contact Jane and tell her, so she can decide to do this or not. Thus in FIG. 5, the step [4] labelled “Fail” and the steps 5 also labelled “Fail” can include the case where the Tester finds that Alpha interacts successfully with Beta prime. For brevity, this “ok” situation was omitted from those labels in the figure.

If the user downloads Beta prime and it fails to hook to her Alpha, then why can't he just download another app from the group (assuming that the group has 2 or more apps) and use it? This is more work for him and it takes longer to connect to Jane. If he has never studied with Jane before, he has nothing invested in time or money in this interaction. He is brittle. He can just walk away.

Why cannot she just keep the original apps in her group? If there is a new Beta, its id is not in her group, so surely the above issue is moot. One reason is that the Beta company might withdraw the old Beta from its app server. The Beta company can also tell the app stores to only offer the new Beta. In this case, at a minimum, Jane should remove Beta from her group. If the other apps in the group still work with teacher Alpha, then potential students can still interact with her.

A variant of FIG. 5 is where the Tester (if it is separate from the Registry) communicates the results directly with Alpha company, Beta company and Jane. This assumes that the necessary addresses of those entities have been told to the Tester by the Registry.

Now suppose Alpha company made a new Alpha. The Registry could test this in the above way, for all groups containing Alpha running in student mode. It can also test for all pairs of teacher app and group, where the teacher app is Alpha. In the latter case, the Registry can run the new teacher Alpha against each student app in a group. If a pair breaks, then the Alpha company and the company that made the student app can be told. And the owner or users of the group can be told.

The testing can include the case of the new teacher app Alpha against the old student app Alpha. Likely, the Alpha company should have tested this. So the Registry might omit this pair testing.

Note that we are not suggesting that the testing by the Registry be entirely automated. But as much as possible should be, as this can be expected to the cheaper than hiring human testers.

A variant is where the Alpha company asks the Registry for all teacher and groups where the teacher or a group app is Alpha. The Alpha company can use this to do the above testing.

The group that Jane defines can have a geographic dependence on the location of the person making a query with her linket or deep link. The location can be the geographic location, as found from the user's network address. So the group of apps returned to the user can differ if the user is in South America or North America, for example. Or using smaller regions as the determinant.

The group can also have a time dependence. The apps in the group can differ, depending on the time of day or date of the query.

The latter 2 paragraphs can be combined to let Jane define a location and time dependence of her group.

Above, we considered the case where there is one teacher app, Alpha, and several student apps. Alpha interacts with these through an API. The point of the API is to enable multiple student apps by a factoring of the interactions to only go through the API. In turn, the API, or a modified version of it, can allow multiple teacher apps on the other side of this API. Perhaps Jane wants maximum flexibility in teaching, so she uses several teacher apps. The earlier discussion can be generalised in a straightforward manner to handle this case.

When she defined the group and the associated teacher app, she now specifies several of the latter. So now if any of the teacher apps is upgraded by its owner to a new version, the above testing of it against all the student apps can be done by the Registry (and Tester).

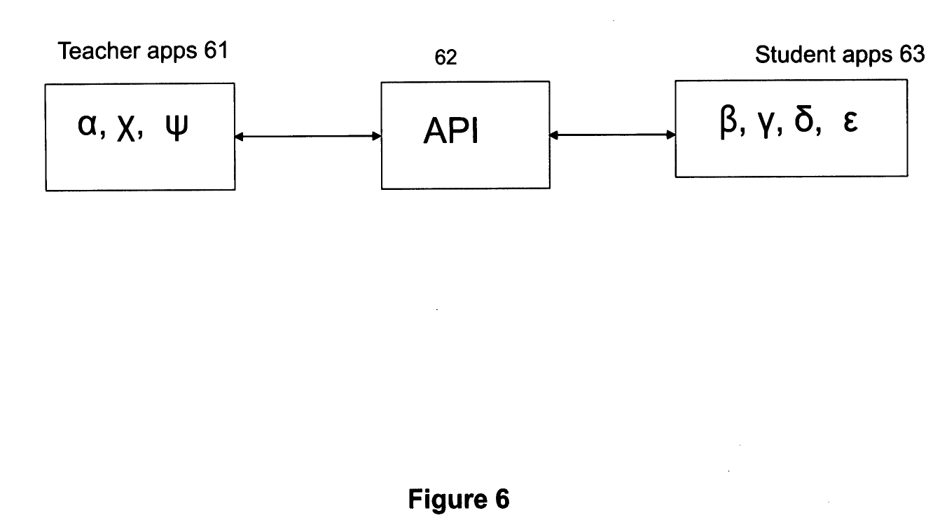

FIG. 6 shows 3 teacher apps in item 61. These use the API 62 to interact with 4 student apps in item 63. Any teacher apps can interact with any of the student apps. Also, in general, a teacher app can interact with several student app instances at the same time. (Though there may be teacher apps designed to only allow 1 to 1 interactions.) The instances may be of different student apps.

4: Minimising Ad Bandwidth;

4.1: Different Instances of an App;

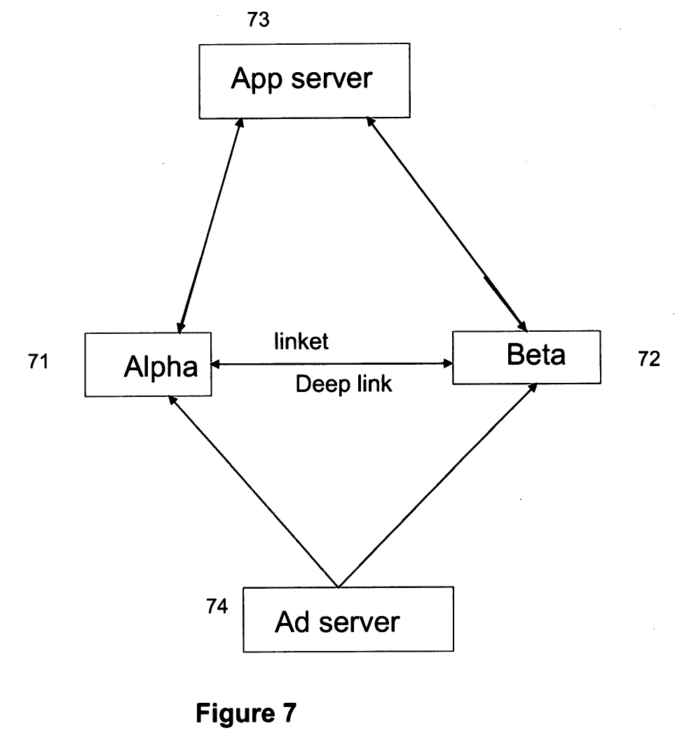

This section extends the work of submission 11, section 12 “Bypassing ad blocker”. Consider FIG. 7. It shows an app instance Alpha 71 interacting with another instance of the same app, Beta 72. Alpha and Beta run on separate devices. Both instances talk to the common App server 73. We suppose that the interaction between Alpha and Beta was via a linket or deep link. Hence the labels on the line between Alpha and Beta.

More generally, Alpha and Beta might not have been using linkets or deep links, but know each other's Internet addresses by any means. For example, they might have initially been interacting with the app server, and not know each other's address. The app server may then have told each instance the other's address.

Suppose the instances get ads from Ad server 74. This could have been initiated by data sent from the app server to Alpha and Beta, the data having an URL of the ad server. So Alpha and Beta, separately, made connections to the ad server, which replied with ads. The ads sent to Alpha and Beta can be different.

Assume that no ad blocker is running on the Alpha and Beta devices, so that the ads can be shown.

The ad server might reduce the bandwidth of ads it sends to them by the following steps. An optional initial step is for Alpha to find the domain or address of the ad server. The address can be found from the Internet packets it gets from the ad server. The domain can be found from parsing any URLs in an ad, to get the domain name of the ad server. Alpha can send one or both of the domain or address to Beta. Beta checks these against the domain or address from the ads it gets. If they match, then Beta knows it and Alpha are getting ads from the same ad server. The ads might be different however. There is no requirement that they are getting the same ads.

The previous steps are optional in cases where it can be assumed a priori that all instances of the app get ads from the same ad server.

Beta knows the address of Alpha, from the Internet packets it gets from Alpha. Beta tells the ad server Alpha's address. The ad server gets Beta's address by inspecting the Internet packets from Beta.

The ad server can pick one of Alpha and Beta. Suppose it picks Beta. Now it only sends ads to Beta. Beta shows the ads. This might be inline in an existing screen of the app or in a popup screen. But Beta also forwards the ads to Alpha. In the simplest case, the ads are unchanged. Alpha shows the ads. If the user of Alpha picks a link or button in an ad, the communication would be between Alpha and the ad server. Beta would not be involved.

The above could also be commanded by the ad server. It sends instructions to Alpha and Beta, asking each for the addresses of other instances. So Alpha sends Beta's address to the ad server, and Beta sends Alpha's address.

The ability of Beta to forward an ad to Alpha, and for Alpha to extract the ad from the messages it gets from Beta, are capabilities that need to be written into the app. Along with the controlling instructions to Beta and Alpha. The instruction to Beta would be to forward the ad it gets from the ad server to Alpha. The instruction to Alpha would be to first listen at a port for messages coming from Beta. Alpha gets this message, which is or encapsulates an ad. Alpha parses the ad from the messages from Beta.

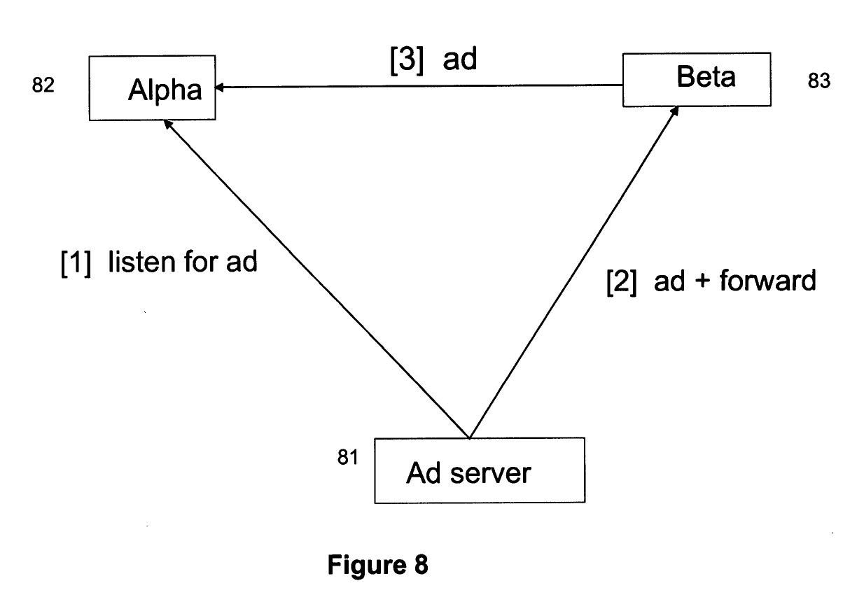

FIG. 8 depicts this. Ad server 81 in step [1] sends a command to Alpha 82, telling it to listen for an ad coming from Beta. Step [2] has the ad server sending an ad and a forward to Alpha command to Beta 83. Beta shows the ad on its screen (not depicted in the figure). In step [3], Beta forwards the ad to Alpha.

Earlier, we said the ads sent to Alpha and Beta are different (in general). Now they are the same, at least in this preferred implementation.

The previous steps mean that the ad server has reduced its outgoing bandwidth by half, at least for the Alpha and Beta instances. This is useful, in part because in some or probably most cases, the outgoing bandwidth from sending ads will be more than the incoming bandwidth when users interact with ads. Likely, many ads will be ignored. So for those ads, there is no incoming bandwidth corresponding to the outgoing bandwidth. And if a user replies to an ad, typically she only sends a small amount of information compared to the size of the ad.

The ad server can scale up to handle more ads being sent out, with the same hardware.

In submission 11, the discussion was similar, but with one app instance, Alpha, running an ad blocker. Then, it was supposed that Beta's address was not on the blacklist of the ad blocker. So Beta would get an ad and alter its links to point to Beta's address, and not to the ad server. Beta forwards the ad to Alpha. If the Alpha user picked a link in the ad, a message goes to Beta, which has a thread listening for this. Beta forwards the message to the ad server.

In the present section, there is no ad blocker. Beta does not need to alter the ad before sending it to Alpha.

Of course, Beta has to do more work, in forwarding the ad to Alpha. This consumes more memory, CPU and outgoing bandwidth to Alpha. Any extra memory might be insignificant, given the typical gigabyte memories of today's mobile devices. And noting that Beta gets the ad anyway.

One way to (try to) optimise the bandwidth is for Beta to wait before forwarding the ad, until it has a message it needs to send to Alpha that arises from the normal non-ad interaction between them. It may be possible that the ad could be appended to the message and sent.

It might seem that this makes no difference, because the outgoing data in total should be the same. But there could be thresholding or step function effects in the Internet packets. If the normal message to Alpha is smaller than the length of the packet that the message will be put into, then perhaps the ad could be fitted in. To the extent that this is possible, it is also an incentive for the ad server to make small ads.

An extension of the above pertains to the ad server picking Beta as the one of the pair to send ads to. If the ad server knows nothing more about Beta and Alpha, it can pick one at random. But suppose it knows more. Like indicators of how much power each device has left, or how much outgoing bandwidth each has. The ad server can use the data to pick the instance that can more easily bear the extra load of relaying the ad.

Related to this is suppose the ad server picks Beta, based on knowledge or estimates that Beta has more capacity to relay. During the interaction between the instances, imagine that the ad server gets data from Alpha and Beta suggesting that the situation is reversed. Maybe Beta's power has drained faster than Alpha's, because Beta is running other processes. The ad server can easily switch to sending ads to Alpha, which then relays to Beta.

This needs extra controlling instructions sent from the ad server. One is “stop forwarding”, sent to Beta to tell it to stop relaying the ad to Alpha. Another is “start forwarding”, sent to Alpha to tell it to start forwarding the ads it gets from the ad server. The latter instruction might implicitly invoke a command on Alpha to stop parsing the messages from Beta for ads. And to start listening on a port for ads from the ad server.

We said that the ad server could change which instance it relays to, based on knowledge of the instances' devices. Another way is for Beta, which we assume to be relaying to Alpha, to ask the ad server to switch to Alpha. This does not need the ad server to know anything about the devices' capacities.

These two choices are not mutually exclusive. Both could be implemented in the app and ad server.

Thus far, we described the simplest case of 2 instances of an app getting ads. Suppose there are several instances of the app, all interacting. Where we assume that the instances know the addresses of at least one other instance.

The app could have a ability to respond to a query from the ad server, where the app instance tells the addresses it knows of other instances. The ad server can ask this of all the instances. It can tell an instance to relay ads it gets to all the other instances whose addresses the first instance knows.

A fine grained version is where the ad server specifies the addresses that an instance will forward to. The addresses are drawn from the addresses sent by that instance to the ad server. But the forwarding list omit some addresses. This avoids some instances getting copies of the same ad from other instances.

An extension of this section is where linkets or deep links are not used. The app instances might initially contact the app server. The latter sends each instance some addresses of other instances, so that the instances can directly interact.

Relaying of ads between app instances opens up another type of interaction. Go back to Alpha and Beta, where Beta relays an ad to Alpha. There are now de facto two instances of the ad. Suppose the ads appear in-screen in the app instances, rather than as new popup windows. The app can be written so that the ad instances directly with each other, just as the “enclosing” app instances to.

That is, when the Alpha user picks a button or link in her ad instance, this causes a message to be sent to Beta, where the message is encapsulated as an ad reply. So when Beta gets the message, it unwraps the ad reply and uses this to cause a change in the in-screen display of the Beta ad instance.

This is symmetric. The Beta user can cause a similar change to the Alpha ad. We now can make a feedback loop between what are effectively two programs with visual elements on two devices. Separate from how the enveloping app instances are interacting.

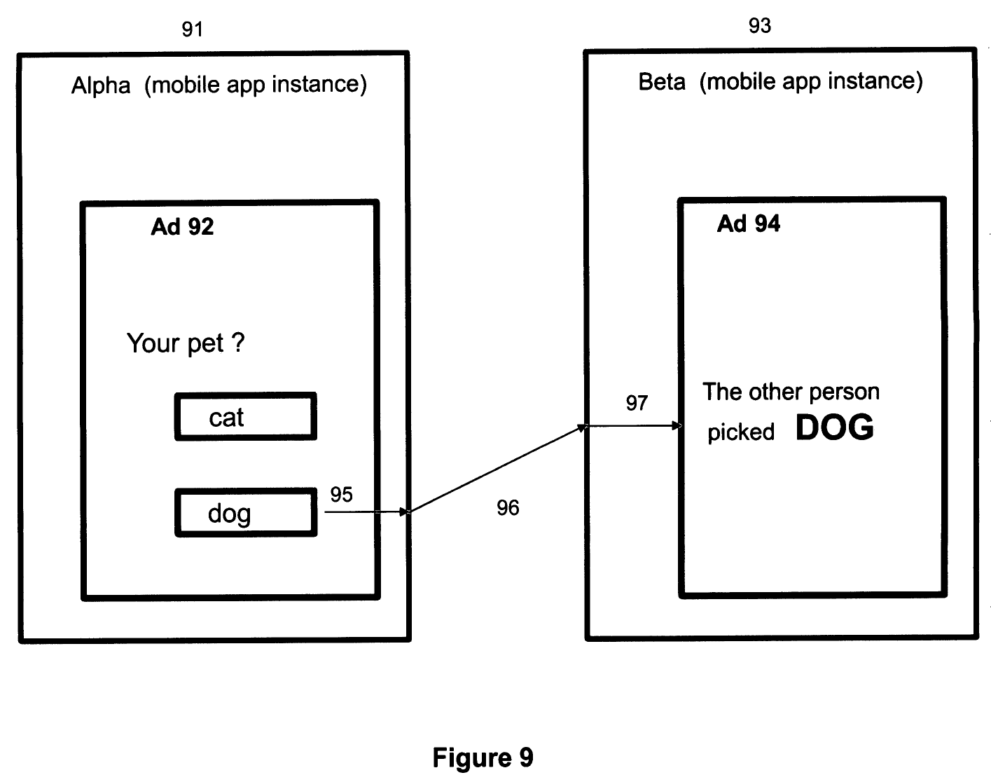

FIG. 9 shows this. Item 91 is the Alpha instance. Item 91 can be supposed to be running in a window on one mobile device. In 91 is ad 92. In that are 2 buttons, cat and dog. The user picks dog. This causes a message 95 to go to the enclosing Alpha 91. Alpha 91 then makes a message 96 which it sends to Beta 93. Beta 93 runs on another mobile device.

The app instance Beta gets the message and sends it (after any necessary unwrapping) as message 97 to ad instance 94. The latter makes the string “The other person picked” plus “DOG”.

FIG. 9 also shows that even when there are 2 instances of the same ad, there is no requirement that the instances show the same visuals.

Strictly, FIG. 9 is not a complete feedback loop. It shows a one way effect of the Alpha ad changing the Beta ad. But if the Beta ad then lets the Beta user make an input that can likewise alter the Alpha ad instance, then we have a closing of the loop.

This feedback loop involves 2 manual steps by the device users (1 by each user). But that is not necessary. When the Alpha ad changed the Beta ad, there could be logic in the Beta ad that used the data sent from the Alpha ad and combined this with steps and data in the Beta ad (and possibly with data in the enclosing Beta instance) to send a reply to the Alpha ad. The reply can be shown in the Alpha ad in some visual manner. This is a feedback loop with only one manual step, by the Alpha user.

If the ads do not use much or any of the data in the enclosing Alpha and Beta instances, then effectively the ads are a pair of programs interacting mainly or only with each other.

The ad instances can also contact the ad server. An alternate implementation is where the ad instances do not directly contact each other, but go through the ad server. That however imposes greater bandwidth and computational load on the server.

4.2: Several Apps;

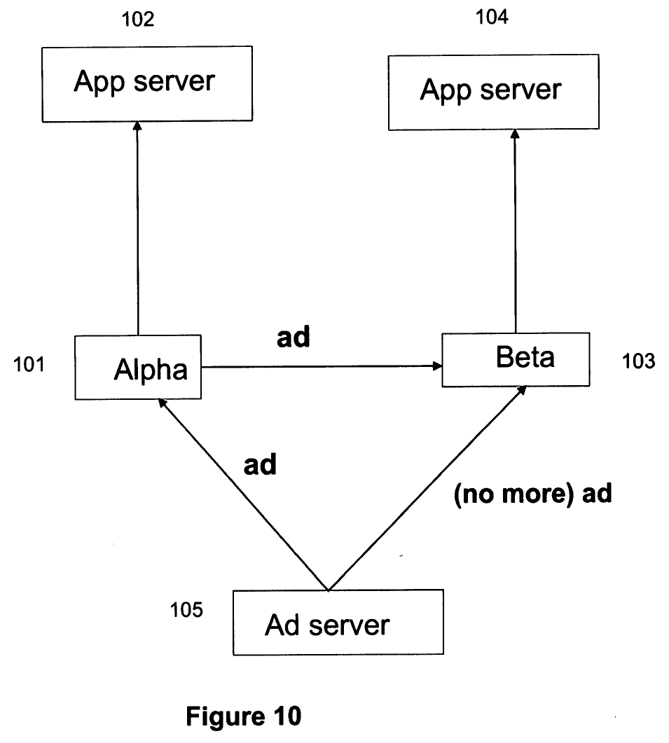

The previous section described the arrangement of FIG. 8, where several instances of the same app were used. A variant is shown in FIG. 10. The app instances Alpha 101 and Beta 103 are instances of different apps. Alpha talks to its App server 102. Beta talks to its App server 104. The app servers are different.

Here, there is no need to use deep links or linkets. Alpha and Beta are apps for different subjects and they do not know each other's address. Suppose they both get ads from the same ad server 105. In general, an ad server will want to show ads on as many apps as possible, so this is likely. The ad server knows the addresses of each app that talks to it.

So the ad server has a list of all apps that it is currently sending ads to. Alpha and Beta are on this list. The ad server sends an ad to Alpha along with Beta's address and port number, and an instruction to send a copy of the ad to Beta. This is shown in the arrow going from Alpha to Beta, with the label ‘ad’. While the arrow going from the ad server to Beta has the label “(no more) ad” to indicate that ads were going to Beta, but now the ad server discontinues sending ads to Beta. As discussed earlier, this is an approximate 50% saving in outgoing bandwidth.

To enable this, the ad server first sends an instruction to Beta. To turn on a process or thread that listens at a given port. It can also tell Beta that the messages to that port come from Alpha's address, which it furnishes to Beta. This is a safety precaution, to minimise the risk of acting on arbitrary messages from arbitrary sources.

The ad server has first ascertained that the Alpha and Beta apps were written to have this functionality. The app companies could have incentive to do so. If the ad server uses the methods described here, it might compensate the companies in some way. The ad server can have an a priori list of the app companies, with ids of their apps. The ad server could compensate more the Alpha app company, because it is Alpha that has more burden in copying the ad to Beta.

The ad server could pick Alpha and Beta based in part on how close they are, as found from their network addresses. If Alpha and Beta take part in the above, over some period of time, then Alpha will get several ads, that it copies to Beta. For load balancing, after some time, the ad server might reverse the roles of Alpha and Beta.

5: Dynamic Deep Links;

Thus far, a given deep link has been a static text string, composed of at least an app identifier and a network address. There could be other items after the address, but we ignore these for clarity. And the deep link can be an output of the Registry, especially if the Registry is queried with a linket.

But the deep link can be executable code, written in some scripting language. The code can be run by an app which gets this as input from an external source, like a Registry. Or perhaps from the Deep Linker (which was explained in earlier submissions).

The code is run by the app, where it is assumed that the app can run code snippets in that given scripting language.

This has advantages. Suppose the code is being parsed by, for example, an ad blocker or antispam filter, that uses one or more blacklists. This parsing can happen outside the app. One blacklist can be of app ids. Another blacklist holds network addresses. So if the deep link is static text, the app ids and network addresses can be readily isolated and tested against the appropriate blacklists.

But this fails against a code block. The ad blocker or antispam filter should not find any hits.

6: Hand Off;

In all of our previous submissions on deep links, 10-15, and this submission, we used a deep link format like item 12 in FIG. 1. Our deep link has an app id and a network address of an instance of the app. (It could have other fields.) In this section, we use a different format. The deep link has an app id, as before. But instead of a network address, it uses a bit string that is a combination of an instance id (that identifies the app instance) and a user id, or simply just an instance id.

One example is a multiplayer game, e.g. madcow. Jane is playing, and there are other players. Each uses her mobile device to play. There is a game server in the cloud that the game instances of the players contact. The game instances might also send messages directly to each other, if they know the network addresses of other players. Though this is not a requirement.

She wants to stop playing. There is another person, Dinesh, who is willing to take up her game position. Suppose the other players do not object. Perhaps it's a friendly game, with no money involved, for instance. In general, he does not need to have the game app already installed on his device. Jane in her app picks an option, “hand off”.

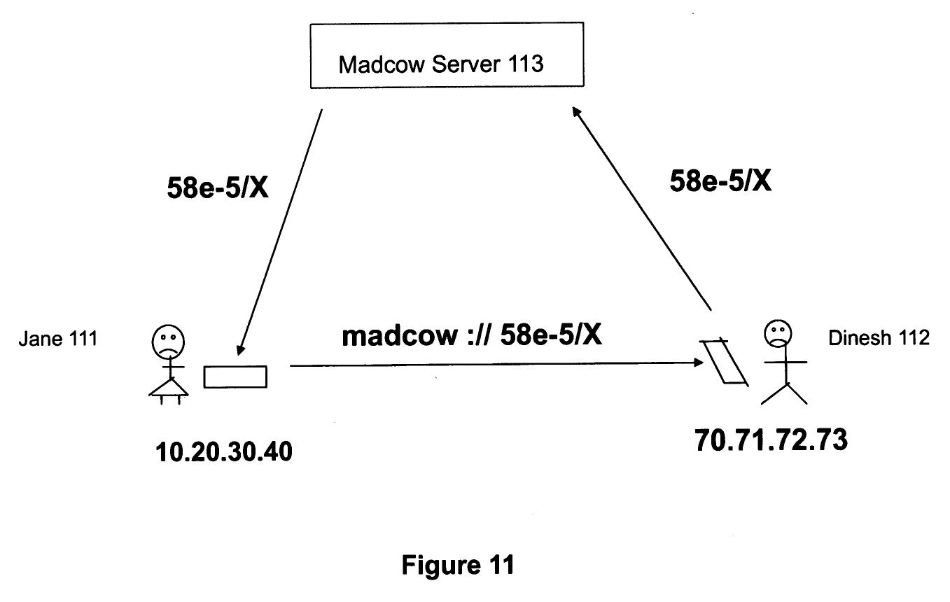

FIG. 11 shows Jane 111 with her device, playing the madcow app with the madcow server 113. There is Dinesh 112 with his mobile device. Jane's device has the Internet address 10.20.30.40, while Dinesh's device has the address 70.71.72.73. Jane asks the server for the id of her game instance. It sends her “58e-5/X”. The “58e” is the id of the multiplayer game. The id is made by the server. The “5” after the dash is her player id. Perhaps there are 7 players and she is the fifth player. X is a pseudorandom bit string. (Not just one character.)

Her app makes a deep link “madcow://58e-5/X”. She sends the deep link to Dinesh by any means, as indicated by the arrow going from her device to his device.

If she knows his email address, she might send it in an email. Or by text message to his phone number. Or if he is near her her app could make a barcode that encodes the deep link. The barcode appears on her device screen in an app window. Dinesh gets the deep link. If it was in a barcode, and he is near Jane, he scans it with his device camera and his device decodes it to the string.

Or she could use an audio server to make a ‘chirp’ (a sound like a bird song). Her mobile device plays it. His device decodes it to get the deep link from the audio server. Or she uses a collision (‘bump’) server. Their devices touch. His device gets the deep link from the collision server.

His device installs madcow if it does not already exist. It is started with the input of the rest of the deep link. His instance sends that to the server. The server extracts X from Dinesh's string and sees that it is the same as the X it sent directly to Jane's device. This tells the server that Jane authorised the action. The server gets the game id and the player id. It now transfers Jane's game position to be controlled by Dinesh from his device. The server can send a farewell message to Jane that appears in her app, telling that the hand off was correctly done.

For clarity, we explicitly separated the game id and the player id. Another equivalent way would merge the two.

The hand off mechanism has the virtue of essentially being a one click (or a few clicks) mechanism for Dinesh, who is not assumed to have any prior history with using the app.

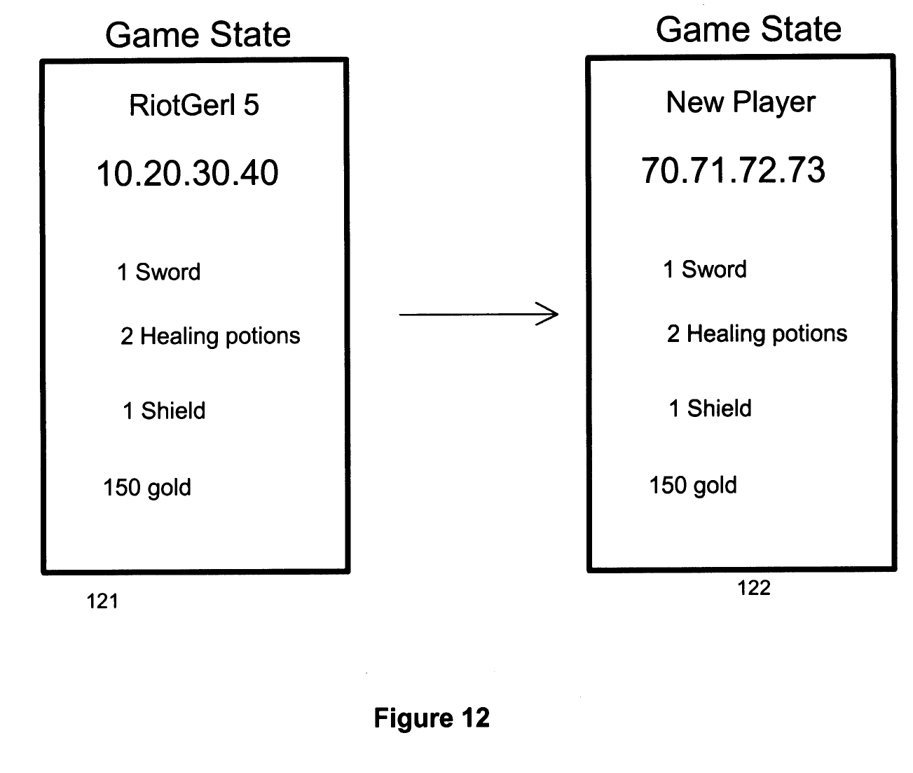

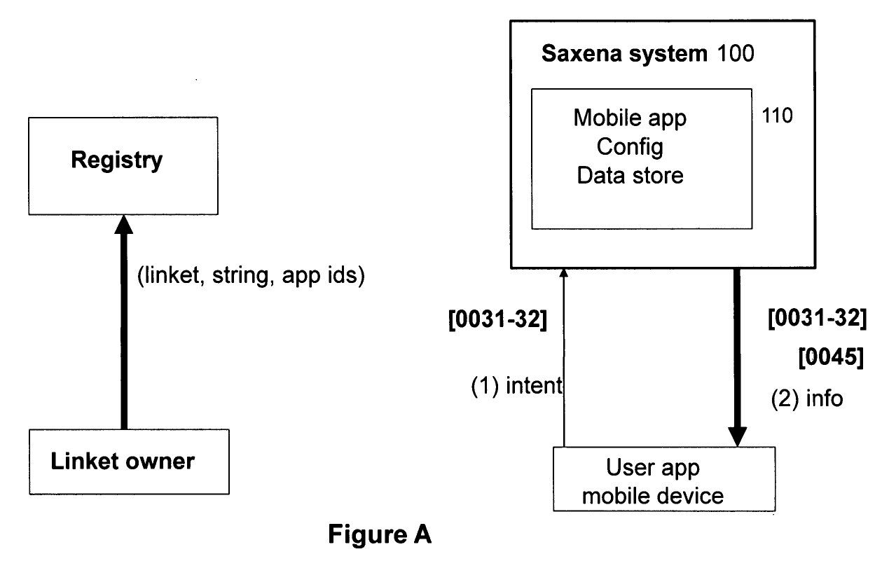

FIG. 12 shows the change in the database of the server. Item 121 is the game state of Jane. Various fields that make up the state are depicted. The top field is her name in the game—“RiotGerl 5”. The next field is her Internet address. The fields beneath this are various of her assets in the game. Imagine that the game is some type of fantasy game. Item 122 is the same data structure, after Dinesh assumes her character. The server has chosen to call his name “New Player”. Presumably he can change this later. The key point is that the address field now says 70.71.72.73, which is the address of his device. The other fields below this are unchanged from when Jane was the player.

The game and user ids of this section are equivalent to the network address of an app instance. The game id is an “address” of a multiuser (game) instance, in a name space known and controlled by the app server. The user id, if written separately from the game id in the deep link, is an “address” of a user (player) within the multiuser instance.

The above can be used with a single player game. A user id is unnecessary in the deep link.

The game id now uniquely identifies Jane within the game instance, because there is no other user.

Instead of X, which was used to avoid spoofing, other means can be adopted.

We claim:

1: A method of a Registry server getting a linket, a string and a group of app identifiers from an entity that owns the linket; where the Registry records the group in a database; where the Registry assigns the string as the group name; where the Registry associates the group with the linket in the database; where Registry gets the group name from a mobile device; where the Registry returns the app identifiers in the group.

2: The method of claim 1, where the Registry sends data about the apps to the mobile device; where the data includes the size of each app.

3: The method of claim 1, where the Registry sends data about the apps to the mobile device; where the data includes a cost of downloading each app.

4: The method of claim 1, where a group has identifiers of one or more subgroups.

5: The method of claim 4, where a subgroup has app identifiers for a given mobile platform.

6: The method of claim 5, where one subgroup is for Android; where one subgroup is for iPhone.

7: The method of claim 1, where the Registry gets the linket and a deep link from a second mobile device; where the deep link has the group name and a network address of the second mobile device; where the Registry stores the linket and deep link.

8: The method of claim 7, where the Registry gets the linket from a third mobile device; where the Registry sends the deep link and app identifiers in the group to the third mobile device.

9: The method of claim 1, where the Registry gets the linket and a network address from the entity; where the Registry makes a deep link; where the deep link has the group name; where the deep link has the network address; where the Registry associates the deep link with the linket in the database.

10: The method of claim 9, where the Registry gets the linket from a third mobile device; where the Registry sends the deep link and app identifiers in the group to the third mobile device.

11: The method of claim 1, where the Registry sends an ad to a fourth mobile device; where the ad has a linket; where the linket is associated with a second deep link; where the second deep link has an identifier of an app in the group.

12: The method of claim 1, where the Registry sends an ad to a second mobile device; where the ad has a linket; where the linket is associated with a second deep link; where the second deep link has an identifier of an app with a same topic as an app in the group.

13: The system of claim 1, where the device sends an identifier of a teacher app to the Registry; where the Registry associates the teacher app with the group; where the teacher app is run in teaching mode with any app Chi in the group; where Chi is run in student mode.

14: A method of an ad server sending ads to an app instance Rho on a first mobile device; the ad server sending ads to an app instance Nu on a second mobile device; where the ad server sends a command to Rho to listen on a network port for a message from Nu; where the ad server sends a command to Nu to forward an ad to Rho; where the ad server sends an ad to Nu.

15: The method of claim 14, where the ad server sends a command to Nu to stop forwarding to Rho.

16: The method of claim 14, where the ad server sends a command to Rho to stop listening for messages from Nu.

17: The method of claim 14, where the ad server sends a command to Nu to listen on a network port for a message from Rho; where an item is selected in the ad shown by Rho; where a message is sent from Rho to Nu; where the message contains data from the selection in the ad shown by Rho; where the data causes a change in the ad shown by Nu.

18: The method of claim 17, where an item is selected in the ad shown by Nu; where a message is sent from Nu to Rho; where the message contains data from the selection; where the data causes a change in the ad shown by Rho.

19: A system of a plurality of mobile devices, each mobile device running an instance of a same multiuser app; each instance communicating with a common app server; where an app instance Chi on a first mobile device makes a deep link; where the deep link has an app identifier; where the deep link has an instance identifier of the Chi instance; where the deep link is sent to a mobile device Phi; where Phi is not running the app; where Phi runs the app, with the instance identifier as input; where the app on Phi sends the instance identifier to the app server; where the app server transfers control of the Chi instance to the app on Phi.

20: The system of claim 19, where Chi makes a barcode encoding the deep link; where the barcode appears on a screen of the first mobile device; where Phi scans the barcode with a camera; where Phi decodes the barcode and extracts the deep link.
